(19) United States
(12) Patent Application Publication
(10) Pub. No.: US 2006/0142175 A1
(43) Pub. Date: Jun. 29, 2006

(54) Washing agent and fabric softener formulations

(76) Inventors: Elke Haiss, Murg (DE); Laure Iltis, Soultz (FR); Petr Kvita, Reinach (CH); Ulrich Menge, Granzach-Wyhlen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/543,942

(22) PCT Filed: Jan. 27, 2004
(86) PCT No.: PCT/EP04/00675

§ 371 Date: Jul. 28, 2005

(30) Foreign Application Priority Data
Feb. 3, 2003 (EP) 03405051.8

(51) Int. Cl. C11D 3/00

(52) U.S. Cl. 510/515

(57) ABSTRACT

One embodiment of the present invention consists of washing agent and/or fabric softener formulations comprising at least one solid composition consisting of (i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions, and (ii) from 5 to 80% by weight, based on the total weight of the solid composition, of one or more liquids; and also novel solid compositions.

The present invention relates to washing agent and fabric softener formulations comprising solid compositions that comprise sorbent carrier materials and from 5 to 80% by weight of non-aqueous liquid or of aqueous emulsions of non-aqueous liquids, and to novel solid compositions.

Solids that contain a high proportion of liquids are normally no longer pulverulent but are usually a glutinous, sometimes viscous mass that is difficult to process further. The aim of the present invention is accordingly to provide washing agent and fabric softener formulations comprising solid compositions that contain a high proportion of non-aqueous liquid or of aqueous emulsions of non-aqueous liquids, especially silicone oils, and that are at the same time still pulverulent and can therefore be further processed readily, that is to say, without special expenditure.

One embodiment of the present invention is concerned with washing agent and/or fabric softener formulations that comprise at least one solid composition consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions, and
(i) from 5 to 80% by weight, based on the total weight of the solid composition, of one or more liquids.

Despite their high liquid content, the solid compositions as such are pulverulent. Such solid compositions can thus readily be further processed. For example, the solid compositions according to the invention can be further processed to form granules, flakes, compacts etc., which may also be encapsulated. It is also possible, however, to use the solid compositions according to the invention as they are.

The liquid is substantially uniformly distributed in the solid composition.

Carrier materials to which preference is given are cellulose materials, microcrystalline cellulose, urea-formaldehyde condensation products and melamine-formaldehyde condensation products.

Carrier materials to which preference is likewise given are highly dispersed, solid polymer compounds formed by polymerisation, polycondensation or by polyaddition reactions or by a combination of such reactions. Such polymer compounds are described, for example, in GB-A-1 323 890 or CH 522 007, and include polycondensation products, especially polycondensed aminoplastics, for example urea-formaldehyde and melamine-formaldehyde polymer compounds, and also vinyl polymers, for example polyacrylonitrile.

Water-insoluble urea-formaldehyde polymer compounds and the preparation of such polymers are known, for example, from A. Renner: Makromolekulare Chemie 149, 1-27 (1971).

The urea-formaldehyde polymer compounds are prepared by reaction of formaldehyde with urea in aqueous solution. The reaction is preferably carried out in two steps. In the first reaction step, urea is reacted with formaldehyde according to a customary condensation procedure, a low molecular weight, water-soluble precondensation product being formed. In the second reaction step, an acid catalyst may be used for the purpose of accelerating the reaction and for crosslinking, there being formed an insoluble, finely divided solid.

Preferably, the carriers contain from 5 to 80% by weight, based on the total weight of the solid composition, of a non-aqueous liquid or of a mixture of such liquids. Such a liquid may be a pure organic material, for example a silicone oil, or a wax-like substance that has been rendered liquid using a non-aqueous solvent. The preparation of many of those substances in pure form, however, is not possible or is possible only with great difficulty, and they are therefore prepared as water-containing formulations, for example as an emulsion of a polyalkylene or of a silicone oil, or as an emulsion of a wax-like material, such as a fatty acid alkanolamide. It is also possible, using such water-containing formulations, to prepare solid compositions having the claimed content of non-aqueous liquid phase, which compositions can then be incorporated into a washing agent and/or fabric softener formulation.

A further advantage is that, when an emulsion is used for the solid compositions, it is not absolutely necessary for water introduced by way of the emulsion to be removed completely in order for the described properties of the solid compositions to be obtained.

A further embodiment comprises using (instead of the pure non-aqueous liquid) an emulsion of one or more non-aqueous liquids.

The solid composition may therefore optionally contain from 0 to 10% by weight water, based on the total weight of the solid composition. The liquid is in that case likewise substantially uniformly distributed in the solid composition.

A further embodiment of the present invention is concerned with washing agent and/or fabric softener formulations comprising at least one solid composition consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions, and
(ii) from 5 to 80% by weight, based on the total weight of the solid composition, of one or more liquids, and
(iii) from 0 to 10% by weight water, based on the total weight of the solid composition.

The non-aqueous liquids in the solid compositions, which can also be used in the form of emulsions, are especially polyalkylenes, silicone oils, polydimethylsiloxanes, fatty acid alkanolamides or polyurethanes.

The content of polyalkylenes, silicone oils, polydimethylsiloxanes, fatty acid alkanolamides and polyurethanes is from 5 to 80% by weight, based on the total weight of the solid composition. The content is preferably from 20 to 80% by weight, especially from 30 to 80% by weight, more especially from 30 to 75% by weight.

Non-aqueous liquids (or emulsions thereof) to which special preference is given are silicone oils.

The silicone oils are usually clear, colourless, neutral, odourless, hydrophobic liquids having molecular weights M_{R} of from 1000 to 150 000, densities of approximately from 0.94 to 0.97 and viscosities of from 10 to 1 000 000 mPa.s. Such oils have long-term thermal stability in air up to approximately 180° C.

A very commonly used silicone oil is poly(dimethylsiloxane), known by the name dimethicone.

Likewise suitable according to the invention are cationic silicone oils, such as, for example, the commercially available products Q2-7224 (a stabilised trimethylsilylamodimethicone; manufacturer: Dow Coming), Dow Corning 929 emulsion (comprising a hydroxylamino-modified silicone, also called amodimethicone), SM-2059 (manufacturer General Electric), SLM-55067 (manufacturer: Wacker) and also Abil®-Quat 3270 and 3272 (diquaternary polydimethylsiloxanes, Quaternium-80; manufacturer: Th. Goldschmidt).

Silicone oils are generally linear polysiloxanes of formula (I)
R₁(CH₃)₂Si—O [symbol] Si(CH₃)(Y)—O [symbol] _{z} [symbol] Si(CH₃)₂—O [symbol] ₘ [symbol] Si(CH₃)(X)—O [symbol] ₙSi(CH₃)₂—R₂ (I)
wherein the individual —Si(CH₃)(Y)—(O)—, —Si(CH₃)₂—O— and —Si(CH₃)(X)—O— units may have any distribution in the polysiloxane chain,
R₁ and R₂ are each independently of the other OH, R or OR, wherein R is C₁-C₆alkyl or a phenyl ring,
m, n and z are each independently of the others an integer, the sum m+n+z giving a molecular weight of from 1000 to 150 000 D,
Y is a radical of formula —R₃—O—(T)_{d}(CH₂)ₑ—H wherein
R₃ is a divalent branched or unbranched C₁-C₆alkylene radical,
d is a number from 5 to 25,
e is 0 or 1,
from 60 to 100% of all T being —CH₂CH₂—O— groups and from 0 to 40% of all T being —CH(CH₃)—CH₂—O— or —CH₂—CH(CH₃)—O—,
X is a monovalent organic radical containing one or more amino groups.

The radical X in the formula (I) is preferably selected from radicals of the general formulae (a) to (f) 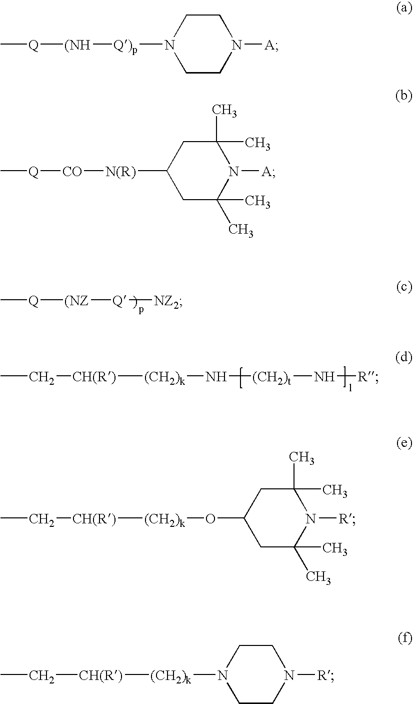
wherein the nitrogen-containing radicals of those formulae may also be quaternised at one or more of the nitrogen atoms by an alkyl group containing from 1 to 8 carbon atoms,
R is C₁-C₆alkyl or phenyl;
R′ is H or CH₃,
k is from 0 to 6, and is preferably 1,
t is from 2 to 8, and is preferably from 2 to 4,
l is from 0 to 3, and is preferably 0 or 1,
R″ is H; —CO—CH₃; —CO—(CH₂)ₖ—OH; —CH₂—(CH₂)ₖ—CH₃; or cyclohexyl,
A is hydrogen or an alkyl group having from 1 to 4 carbon atoms,
Q and Q′ are each a divalent, branched or unbranched alkylene radical having from 1 to 4 carbon atoms,
p is 0 or 1,
   and all of the radicals Z present are each independently of any others hydrogen, C₁-C₆alkyl unsubstituted or substituted by one or more hydroxyl groups; cyclohexyl or a radical —CO—G, wherein G is C₁-C₆alkyl unsubstituted or substituted by one or more hydroxyl groups.

Special preference is given to polyorganosiloxanes of formula (I) wherein X is a radical of formula (c) or (d), especially a radical of formula —(CH₂)₃—NH—(CH)₂—NH₂ or of formula —(CHRₐ)₃—NH₂ in which one of the radicals Rₐ is CH₃ and the other two are each H, or of formula —(CH₂)₃—NH₂.

Further suitable polyorganosiloxanes are those of formula (II) 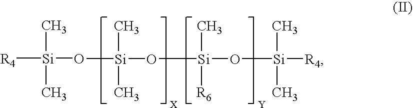
wherein
R₄ is OH, OR₅ or CH₃,
R₅ is CH₃ or CH₂CH₃,
R₆ is C₁-C₂₀alkoxy, CH₃, CH₂CHR₇CH₂NHR₈ or CH₂CHR₇CH₂N(COCH₃)R₈, 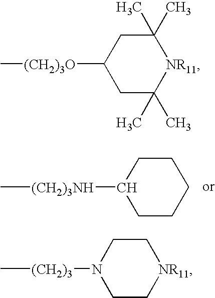
R₇ is H or CH₃,
R₈ is H, CH₂CH₂NHR₉, C(═O)—R₁₀ or (CH₂)_{z}—CH₃,
z is from 0 to 7,
R₉ is H or C(═O)—R₁₀,
R₁₀ is CH₃, CH₂CH₃ or CH₂CH₂CH₂OH,
R₁₁ is H or CH₃,
   and the sum of X and Y is from 40 to 4000;
   further suitable polyorganosiloxanes are those of formula (III)
   (R₁₂)_{V}(R₁₃)_{W}Si—A—B (III),
   wherein
R₁₂ is CH₃, CH₃CH₂ or phenyl,
R₁₃ is —O—Si or —O—R₁₂,
the sum of v and w is 3, and v is not equal to 3,
A is —CH₂CH(R₁₄)(CH₂)_{K},
B is —NR₁₅((CH₂)ₗ—NH)ₘR₁₅ or 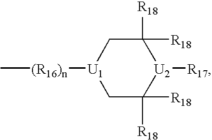
n is 0 or 1,
U₁ is N when n is 0, and U₁ is CH when n is 1,
l is from 2 to 8,
k is from 0 to 6,
m is from 0 to 3,
R₁₄ is H or CH₃,
R₁₅ is H, C(=O)
R₁₉, CH₂(CH₂)ₚCH₃ or 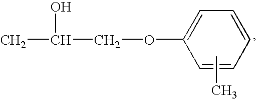
p is from 0 to 6,
R₁₆ is NH, O, OCH₂CH(OH)CH₂N(butyl) or OOCN(butyl),
R₁₇ is H, linear or branched C₁-C₄alkyl, phenyl or CH₂CH(OH)CH₃,
R₁₈ is H or linear or branched C₁-C₄alkyl,
R₁₉ is CH₃, CH₂CH₃ or (CH₂)_{q}OH,
q is from 1 to 6,
U₂ is N or CH;
   further suitable polyorganosiloxanes are those of formula (IV) 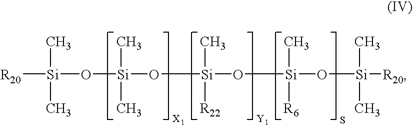
   wherein
R₆ is as defined above,
R₂₀ is OH, OR₂₁ or CH₃,
R₂₁ is CH₃ or CH₂CH₃,
R₂₂ is R₂₃—(EO)ₘ—(PO)ₙ—R₂₄,
m is from 3 to 25,
n is from 0 to 10,
R₂₃ is a direct bond or CH₂CH(R₂₅)(CH₂)ₚR₂₆,
p is from 1 to 4,
R₂₄ is H, R₂₇, CH₂CH(R₂₅)NH₂ or CH(R₂₅)CH₂NH₂,
R₂₅ is H or CH₃,
R₂₆ is O or NH,
R₂₇ is linear or branched C₁-C₈alkyl or Si(R₂₈)₃,
R₂₈ is linear or branched C₁-C₈alkyl, OCH₃ or OCH₂CH₃,
EO is —CH₂CH₂O—,
PO is —CH(CH₃)CH₂O— or —CH₂CH(CH₃)O—,
   and the sum of X₁,Y₁ and S is from 20 to 1500;
   further suitable polyorganosiloxanes are those of formula (V) 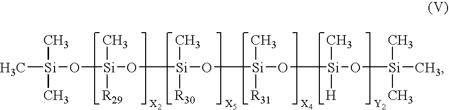
   wherein
R₂₉ is linear or branched C₁-C₂₀alkoxy, or CH₂CH(R₇)R_{α},
R₇ is as defined above,
R_{α} is linear or branched C₁-C₂₀alkyl,
R₃₀ is aryl, aryl substituted by linear or branched C₁-C₁₀alkyl or linear or branched C₁-C₂₀alkyl substituted by aryl,
R₃₁ is 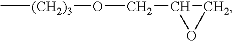
   the sum of X₂, X₃, X4 and Y₂ is from 20 to 1500, wherein X₃, X₄ and Y₂ may each independently of the others be 0;
or a mixture thereof.
   Further suitable polyorganosiloxanes are those of formula (VI) 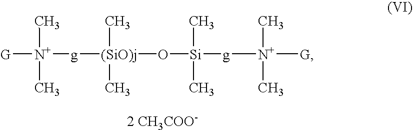
   wherein g is 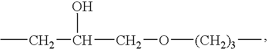
   and G is C₁-C₂₀alkyl.

Further suitable polyorganosiloxanes are those known under the name Magnasoft® HSSD (registered trade mark of Crompton Corporation).

Further suitable polyorganosiloxanes are those of formula (VII) 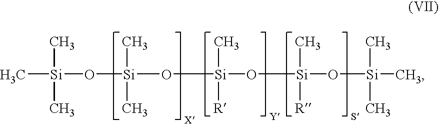
wherein
R″ is CH₂CH₂CH₂N(R′″)₂,
R′″ is linear or branched C₁-C₄alkyl,
R′ is (CH₂)_{x″}—(EO)ₘ—(PO)ₙ—R″″,
m is from 3 to 25,
n from 0 O 10,
X″ is from 0 to 4,
R″″ is H or linear or branched C₁-C₄alkyl,
EO is —CH₂CH₂O—,
PO is —CH(CH₃)CH₂O— or —CH₂CH(CH₃)O—,
   and the sum of X′, Y′ and S′ is from 40 to 300.

Non-aqueous liquids (or emulsions thereof) to which special preference is likewise given are fatty acid alkanolamides.

Suitable fatty acid alkanolamides include, for example, those of formula (VIII) 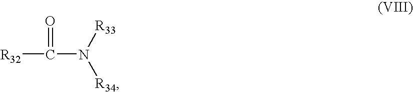
wherein
R₃₂ is a saturated or unsaturated hydrocarbon radical containing from 10 to 24 carbon atoms,
R₃₃ is hydrogen or a radical of formula —CH₂OH, —(CH₂CH₂O)_{c}H or 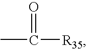
wherein c is a number from 1 to 10 and R₃₅ has the definition given above for R₃₂, and
R₃₄ is a radical of formula 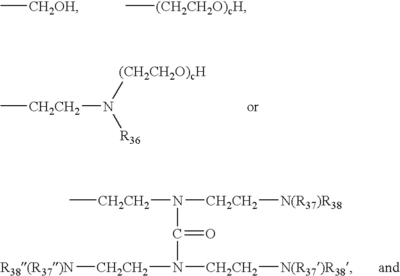
c is as defined above,
R₃₆ is hydrogen or a radical of formula 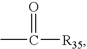
wherein R₃₅ is as defined above,
R₃₇, R₃₇′ and R₃₇″ have identical or different meanings and have the definitions given above for R_{33,} and
R_{38,} R₃₈′ and R₃₈″ have identical or different meanings and are a radical of formula 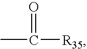
wherein R₃₅is as defined above.

R₃₂ and R₃₅ are preferably a saturated or unsaturated hydrocarbon radical having from 14 to 24 carbon atoms. Saturated hydrocarbon radicals are preferred.

R₃₃ is preferably hydrogen, —CH₂OH or a radical of formula

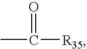

R₃₄ is preferably a radical of formula 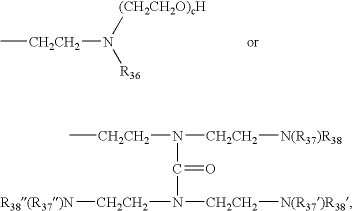
wherein R₃₆, R₃₇, R₃₇′, R₃₇″, R_{38,} R₃₈′ and R₃₈″ have the definitions and preferred meanings given above.

c is preferably a number from 1 to 5.

Preference is given to fatty acid alkanolamides of formula (VIIIa) 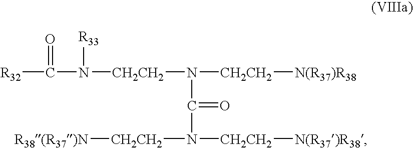
wherein R₃₂, R₃₃, R₃₇, R₃₇′, R₃₇″, R₃₈, R₃₈′ and R₃₈″ are as defined above.

Preference is given to fatty acid alkanolamides of formula (VIIIa), wherein R₃₃, R₃₇, R₃₇′ and R₃₇″ are hydrogen or —CH₂OH.

Preference is given furthermore to fatty acid alkanolamides of formula (VIIIb) 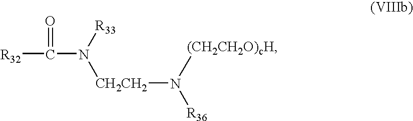
wherein R_{32,} R_{33,} R₃₆ and c are as defined above.

Preference is given to fatty acid alkanolamides of formula (VIIIb), wherein R₃₃ and R₃₆ are hydrogen or a radical of formula

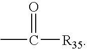

R₃₃is preferably hydrogen.

Non-aqueous liquids (or emulsions thereof) to which special preference is likewise given are polyethylene and polyethylene waxes.

Dispersed polyethylene (polyethylene wax) is known and described in detail in the prior art (see, for example, DE-C-2 359 966, DE-A-2 824 716 and DE-A-1 925 993). Dispersed polyethylene is normally a polyethylene having functional groups, especially having COOH groups, some of which may be esterified. Such functional groups are introduced by oxidation of the polyethylene. The functionality can, however, also be obtained by copolymerisation of ethylene with, for example, acrylic acid. The dispersed polyethylenes have, at 20° C., a density of at least 0.9 g/cm³, an acid number of at least 5 and a saponification number of at least 10. The drop point is preferably in the range from 100 to 150° C. Dispersed polyethylenes that, at 20° C., have a density of from 0.95 to 1.05 g/cm³, an acid number of from 10 to 60 and a saponification number of from 15 to 80 are especially preferred. Such material is generally commercially available in the form of flakes, pellets and the like. It is also possible to use a mixture of such dispersed polyethylenes.

The polyethylene wax is usually used in the form of a dispersion. Various emulsifiers are suitable for the preparation of such dispersions, the preparation being described in detail in the prior art.

Non-aqueous liquids (or emulsions thereof) to which special preference is likewise given are polyurethanes.

Suitable polyurethanes are described, for example, in WO 02/81611 A1 Such polyurethanes are obtainable by reaction of
a) a diisocyanate with
b) a polyether containing at least one hydroxyl group,
c) optionally, a diol derived from an aliphatic radical containing from 2 to 12 carbon atoms, and
d) an agent that introduces a water-solubility-imparting group.

Examples of component b) include polyoxyethylene glycol, polyoxyethylene propylene glycol and polyoxyethylene tetramethylene glycol. Further examples may include addition products obtained by the addition of ethylene oxide alone, or of ethylene oxide with one or more than one other alkylene oxide, for example propylene oxide or butylene oxide, to polyalkylene polyamines of low molecular weight, for example ethylenediamine, diethylenetriamine and triethylenetetramine or hydrazine. Components b) preferably have a molecular weight of from 600 to 16 000, especially from 600 to 3000.

Component b) is preferably a polyether of formula (g)
R₄₀—(O—X₁)ₙ—OH (g),
wherein
R₄₀ is hydrogen or C₁-C₁₂alkyl,
X₁ is C₂-C₆alkylene and
n is a number from 2 to 100,
or a polyether of formula (h) 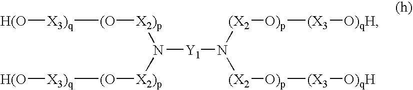
wherein
X₂ and X₃ have the definitions given above for X₁, Y₁, is a direct bond or C₂-C₆alkylene, and
p and q are a number from 2 to 100.

In formula (h), the X₂ groups and X₃ groups may both be identical to or different from one another. The same applies to suffixes p and q.

R₄₀ as C₁-C₁₂alkyl is a straight-chain or branched alkyl radical, for example methyl, ethyl, n-propyl, isopropyl, n-butyl, sec-butyl, tert-butyl, pentyl, isopentyl, tert-pentyl, hexyl, heptyl, octyl, isooctyl, nonyl or decyl or the like. C₁-C₆Alkyl radicals are preferred and C₁-C₄alkyl radicals are especially preferred.

R₄₀ is preferably C₁-C₁₂alkyl, for which the definitions and preferred meanings given above apply.

X₁ is preferably C₂-C₄alkylene, for example groups of formulae —CH₂—CH₂—, —CH₂—CH₂—CH₂—, —CH(CH₃)—CH₂— and —CH₂—CH(CH₃)—, and linear or branched butylene. The corresponding branched alkylene groups are preferred.

For n, a number from 5 to 50, especially from 5 to 30, is preferred n is especially preferably a number from 10 to 25.

More especially preferred are components b) of formula (g) wherein R₄₀ is C₁-C6alkyl, X₁ is C₂-C₄alkylene and n is a number from 5 to 30.

X₂ and X₃ are preferably C₂-C₄alkylene, especially C₂-C₃alkylene, for example groups of formula —CH₂—CH₂— and —CH₂—CH₂—CH₂—. X₂ is preferably a group of formula —CH₂—CH₂—CH₂—. X₃ is preferably a group of formula —CH₂—CH₂—. Y₁ denoting alkylene is preferably C₂-C₄alkylene, especially a group of formula —CH₂—CH₂—.

p and q are preferably a number from 2 to 30, especially from 2 to 10. Numbers from 2 to 6 are more especially preferred.

More especially preferred are components b) of formula (h) wherein X₂ and X₃ are C₂-C₄alkylene, Y₁ is a direct bond or C₂-C₄alkylene and p and q are a number from 2 to 30.

Components c) can optionally be used as chain extenders. Component c) is a diol derived from an aliphatic radical that contains from 2 to 12 carbon atoms and that may be either linear or branched. C₂-C₈Alkanediols are preferred, especially C₂-C₆alkanediols. C₂-C4Alkanediols are more especially preferred. Examples of component c) are as follows: ethylene glycol, 1,3-propylene glycol, 1,2-propylene glycol, 1,5-pentanediol, neopentyl glycol, 1,6-hexanediol, 1,4-butanediol and, especially, 1,3-butanediol.

Components c) are preferably used in combination with component b) of formula (g), whereas for components b) of formula (h), the additional use of a component c) is normally not necessary.

Examples of water-solubility-imparting groups introduced by component d) are sulfate groups and, preferably, sulfite groups. Agents that introduce a water-solubility-imparting group include, for example, the corresponding alkali metal salts or alkali metal hydrogen salts, especially the corresponding sodium salts. Alkali metal hydrogen sulfites are especially preferred. An example of such an agent is NaHSO₃.

Non-aqueous liquids (or emulsions thereof) to which preference is likewise given are mixtures of fatty acid amides with polyethylene waxes. Such mixtures are described, inter alia, in WO 02/079364.

Such a mixture consists of:
(a) at least one fatty acid amide of formula (i) 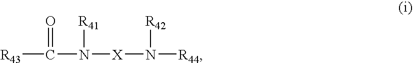
wherein R₄₁, and R₄₂ are each independently of the other hydrogen or C₁-C₄alkyl,
R₄₃ is a C₈-C₂₂alkyl radical,
R₄₄ is hydrogen or a radical of formula R₄₅—C(O)—, wherein R₄₅ has the definition given above for R₄₃, and
X is a C₂-C₁₂alkylene radical which may or may not be interrupted by —O— or —NH—;
or a salt thereof, and
(b) at least one polyethylene wax.

Of special interest are compounds of formula (i) wherein
R₄₁ and R₄₂ are hydrogen,
R₄₄ is a radical of formula R₄₅—C(O)—,
R₄₃ and R₄₅ are each independently of the other a C₁₄-C₂₀alkyl radical, especially a
C₁₆-C₁₈alkyl radical, and
X is a radical of formula —CH₂CH₂—NH—CH₂CH₂—.

The polyethylene waxes used as component (b) are generally those having functional groups, especially carboxyl groups, some of which may also be esterified. Such functional groups are introduced, for example, by oxidation of the polyethylene. It is also possible, however, to obtain the functionality by copolymerisation of ethylene with, for example, acrylic acid. The polyethylene waxes preferably exhibit, at 20° C, a density of at least 0.9 g/cm³, an acid number of at least 5 and a saponification number of at least 10. Special preference is given to polyethylene waxes where, at 20° C., the density is from 0.95 to 1.05 g/cm³, the acid number is from 10 to 60 and the saponification number is from 15 to 80.

Corresponding polyethylene waxes and processes for the preparation thereof are known, for example, from DE-C-2 359 966, DE-A-2 824 716 and DE-A-1 925 993.

An especially preferred embodiment of the present invention is concerned with washing agent and/or fabric softener formulations comprising at least one solid composition consisting of
(i) at least one carrier material from the group consisting of wood flour, papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
(ii) from 5 to 80% by weight, based on the total weight of the solid composition, of polyalkylene, silicone oil, polydimethylsiloxane, fatty acid alkanolamide and/or polyurethane, or a mixture thereof and
(iii) from 0 to 10% by weight water, based on the total weight of the solid composition.

A more especially preferred embodiment of the present invention is concerned with washing agent and/or fabric softener formulations comprising at least one solid composition consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
(ii) from 20 to 80% by weight, especially from 30 to 80% by weight, more especially from 30 to 75% by weight, based on the total weight of the solid composition, of polyalkylene, silicone oil, polydimethylsiloxane, fatty acid alkanolamide and/or polyurethane, or a mixture thereof and
(iii) from 0 to 10% by weight water, based on the total weight of the solid composition.

The solid compositions according to the invention can be used as such, that is to say in the form of powders, in the washing agent and/or fabric softener formulation.

The solid compositions can, however, also be processed to form other conventional further processed forms, for example to form built-up granules, flakes, compacts or extrudates, which are then added to the washing agent and/or fabric softener formulations.

Any method that is known from the literature and customary can be used for the granulation. In principle, both continuous and discontinuous processing methods are suitable.

Among the build-up agglomeration methods, special preference is given to mixing agglomeration, for example in a ploughshare mixer or a granulating mixer, and also to spray-drying granulation or fluidised bed granulation.

The granules may additionally comprise further constituents. The nature and the amount of the constituents used depends on the application in question. The granules may also, in addition, be encapsulated.

The solid compositions comprising polyalkylene emulsions, silicone oils, polydimethyl-siloxanes and/or fatty acid alkanolamides are used especially in fabric softeners or in washing compositions that comprise fabric softener substances, and also in special products for textile care. The polyurethane-containing compositions according to the invention are used especially in compositions for improving elasticity/crease properties.

The present invention relates also to the use of at least one solid composition consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions, and
(ii) from 5 to 80% by weight, based on the total weight of the solid composition, of one or more liquids,
   in washing agent and fabric softener formulations.

The solid compositions are pulverulent despite their high liquid content.

The liquid is substantially uniformly distributed in the solid composition. In respect of the carrier materials, and the non-aqueous liquids and emulsions thereof, all of the above definitions and preferred meanings apply.

The present invention likewise relates to the use of at least one solid, pulverulent composition consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
(ii) from 20 to 80% by weight, especially from 30 to 80% by weight, more especially from 30 to 75% by weight, based on the total weight of the solid composition, of polyalkylene, silicone oil, polydimethylsiloxane, fatty acid alkanolamide and/or polyurethane, or a mixture thereof and
(iii) from 0 to 10% by weight water, based on the total weight of the solid composition,
   in washing agent and fabric softener formulations.

The present invention relates also to the use of a solid pulverulent composition as described above that is in the form of granules. In addition to being used in conventional washing agent and fabric softener formulations, the solid composition is also used in washing agent additives, for example In pretreatment and aftertreatment compositions, in stain-removing salts, in washing-power enhancers, in bleaching agents or in UV-protection enhancers, as well as in washing agent compositions comprising a fabric softener.

The washing agent formulations according to the invention may be in solid, liquid, gel-like or paste-like form, for example in the form of liquid non-aqueous washing agent compositions containing not more than 5% by weight, preferably from 0 to 1 % by weight, water and may be based on a suspension of a builder substance in a non-ionic surfactant, for example as described in GB-A-2 158 454.

The washing agent formulations according to the invention may also be in the form of powders, (super)compact powders, in the form of single-layer or multi-layer tablets (tabs), in the form of washing agent bars, washing agent blocks, washing agent sheets, washing agent pastes or washing agent gels, or in the form of powders, pastes, gels or liquids that are used in capsules or in pouches (sachets).

Preferably, the washing agents are in the form of non-aqueous formulations, powders, tabs or granules.

The present invention accordingly relates also to washing agent formulations containing
I) from 5 to 90% A) of at least one anionic surfactant and/or B) at least one non-ionic surfactant, based on the total weight of the washing agent formulation,
II) from 5 to 70% C) of at least one builder substance, based on the total weight of the washing agent formulation,
III) from 0 to 30% D) of at least one peroxide and, optionally, at least one activator, based on the total weight of the washing agent formulation,
IV) from 0.1 to 70% E) of at least one solid composition consisting of
   (i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
   (ii) from 5 to 80% by weight, based on the total weight of the solid composition, of one or more liquids and
   (iii) from 0 to 10% by weight water, based on the total weight of the solid composition,
V) from 0 to 60% F) of at least one further additive, based on the total weight of the washing agent formulation, and
VI) from 0 to 12% G) water, based on the total weight of the washing agent formulation.

All of the preferred meanings given above apply to the solid composition E).

The present invention accordingly relates especially also to washing agent formulations containing
I) from 5 to 70% A) of at least one anionic surfactant and/or B) at least one non-ionic surfactant, based on the total weight of the washing agent formulation,
II) from 5 to 50%, preferably from 5 to 40% by weight, C) of at least one builder substance, based on the total weight of the washing agent formulation,
III) from 0 to 12% D) of at least one peroxide and, optionally, at least one activator, based on the total weight of the washing agent formulation and
IV) from 0.2 to 50%, preferably from 0.3 to 40% by weight, E) of at least one solid composition consisting of
   (i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
   (ii) from 5 to 80% by weight, based on the total weight of the solid composition, of polyalkylene, silicone oil, polydimethylsiloxane, fatty acid alkanolamide and/or polyurethane, or a mixture thereof and
   (iii) from 0 to 10% by weight water, based on the total weight of the solid composition,
V) from 0 to 60% F) of at least one further additive, based on the total weight of the washing agent formulation, and
VI) from 0 to 12% G) water, based on the total weight of the washing agent formulation.

The sum of the percentages by weight of components I) to VI) in a formulation is always 100%.

All of the preferred meanings mentioned above apply to the solid composition in E).

The anionic surfactant A) may be, for example, a sulfate, sulfonate or carboxylate surfactant, or a mixture of those surfactants. Preferred sulfates are those having from 12 to 22 carbon atoms in the alkyl radical, or alkyl ethoxysulfates in which the alkyl radical contains from 10 to 20 carbon atoms and in which the head group contains on average 2 or 3 ethoxy units. Preferred sulfonates are, for example, alkyl benzenesulfonates having from 9 to 15 carbon atoms in the alkyl radical and/or alkyl naphthalenesulfonates having from 6 to 16 carbon atoms in the alkyl radical in question. The cation in the anionic surfactants is preferably an alkali metal cation, especially sodium. Carboxylates that are preferred are alkali metal sarcosinates of formula R₄₆—CO—N(R₄₇)—CH₂COOM¹, wherein R₄₆ is alkyl or alkenyl having from 8 to 18 carbon atoms in the alkyl or alkenyl radical, R₄₇ is C₁-C₄alkyl and M¹ is an alkali metal.

The non-ionic surfactant B) may be, for example, a condensation product of from 3 to 8 mol of ethylene oxide with 1 mol of primary alcohol, which alcohol contains from 9 to 15 carbon atoms.

As builder substance C) there come into consideration, for example, alkali metal phosphates, especially tripolyphosphates, carbonates or hydrogen carbonates, especially sodium salts thereof, silicates, aluminium silicates, polycarboxylates, polycarboxylic acids, organic phosphonates, aminoalkylenepoly(alkylenephosphonates) and mixtures of those compounds. Silicates that are especially suitable are sodium salts of crystalline layered silicates of formula NaHSiₜO₂ₜ₊₁·pH₂O or Na₂SiₜO₂ₜ₊₁·pH₂O, wherein t is a number from 1.9 to 4 and p is a number from 0 to 20. Among the aluminium silicates, preference is given to those obtainable commercially under the names zeolite A, B, X and HS, and also to mixtures comprising two or more of those components.

Among the polycarboxylates, preference is given to the polyhydroxycarboxylates, especially citrates, and acrylates and also copolymers thereof with maleic anhydride. Preferred polycarboxylic acids are nitrilotriacetic acid, ethylenediaminetetraacetic acid and ethylenediamine disuccinate, either in racemic form or in the enantiomerically pure S,S form. Phosphonates and aminoalkylenepoly(alkylenephosphonates) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid.

As peroxide component D) there come into consideration, for example, the organic and inorganic peroxides known in the literature and obtainable commercially that bleach textile materials at conventional washing temperatures, for example at from 10 to 95° C. The organic peroxides are, for example, mono- or poly-peroxides, especially organic peracids or salts thereof, such as phthalimidoperoxycaproic acid, peroxybenzoic acid, diperoxy-dodecanoic diacid, diperoxynonanoic diacid, diperoxydecanoic diacid, diperoxyphthalic acid or salts thereof. Preferably, however, inorganic peroxides are used, for example persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability. The peroxides are added to the washing agent preferably by mixing the components, for example using a screw metering system and/or a fluidised bed mixer.

The washing agent compositions may likewise comprise one or more optical brighteners, for example from the class bis-triazinylaminostilbenedisulfonic acid, bis-triazolylstilbene-disulfonic acid, bis-styrylbiphenyl and bis-benzofuranylbiphenyl, a bis-benzoxalyl derivative, bis-benzimidazolyl derivative, coumarin derivative or a pyrazoline derivative. The washing agent compositions may also comprise suspending agents for dirt, for example sodium carboxymethyl cellulose, pH regulators, for example alkali metal or alkaline earth metal silicates, foam regulators, for example soap, salts for regulating the spray-drying and the granulating properties, for example sodium sulfate, fragrances and optionally also antistatics and fabric softeners, enzymes, such as amylases, bleaching agents, pigments and/or toning agents. It will be understood that such constituents must be stable towards the bleaching agent used. In addition, the washing agent formulation may comprise polymers which, during the washing of textiles, prevent staining caused by dyes In the washing liquor which have been released from the textiles under the washing conditions.

In addition, the washing agent compositions according to the invention may also comprise so-called perborate activators, for example TAED or TAGU. Preference is given to TAED, which is preferably used in an amount of from 0.05 to 5% by weight, especially from 0.2 to 1.7% by weight, based on the total weight of the washing agent composition.

The detergent agents are usually formulated that the washing liquor has pH value of about 6.5-11, preferably 7.5-11 during the whole washing procedure. The liquor ration in the washing process is usually 1:4 to 1:40, preferably 1:4 to 1:15, more preferably 1:4 to 1:10, especially preferably 1:5 to 1:9.

The washing procedure is usually done in washing machine. There are various types of washing machines, for example:
top-loader-washing machines with a verticle rotating axis; these machines, which have usually a capacity of about 45 to 83 litres, are used for washing processes at temperatures of 10-50° C. and washing cycles of about 10-60 minutes. Such types of washing machines are often used in the USA;
front-loader-washing machine with a horizontal rotating axis; these machines, which have usually a capacity of about 8 to 15 litres, are used for washing processes at temperatures of 30-95° C. and washing cycles of about 10-60 minutes. Such types of washing machines are often used in Europe;
top-loader-washing machines with a verticle rotating axis; these machines, which have usually a capacity of about 26 to 52 litres, are used for washing processes at temperatures of 5-25° C. and washing cycles of about 8-15 minutes. Such types of washing machines are often used in Japan. The present Invention relates also to fabric softener compositions that comprise the above-defined solid composition. Fabric softeners, especially hydrocarbon fabric softeners, used in the fabric softener formulations according to the invention are selected especially from the following compound classes:

(i) cationic quaternary ammonium salts. The counter-ion of such cationic quaternary ammonium salts may be a halide, for example chloride or bromide, dimethyl sulfate or other ions well known from the literature. Preferably, the counter-ion is dimethyl sulfate or any alkyl sulfate or halide, dimethyl sulfate usually being preferred for the articles of this invention that are added to the dryer.

Examples of cationic quaternary ammonium salts include, without there being any limitation thereto:

(1) Acyclic quaternary ammonium salts that contain at least two C₈-C₃₀-, preferably C₁₂-C₂₂-alkyl or -alkenyl chains, for example: ditallow dimethylammonium dimethyl sulfate, di(hydrogenated tallow)dimethylammonium dimethyl sulfate, di(hydrogenated tallow)dimethylammonium methyl chloride, distearyl-dimethylammonium dimethyl sulfate, dicocodimethylammonium dimethyl sulfate and the like. In particular, the textile softener compound is preferably a water-insoluble quaternary, ammonium material comprising a compound having two C₁₂-C₁₈-alkyl or -alkenyl groups that are bonded to the molecule by at least one ester bond. It is especially preferred when two ester bonds are present in the quaternary ammonium material. An especially preferred ester-bonded quaternary ammonium material for use in this invention may be represented by the following formula: 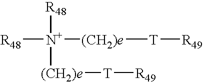
wherein
each R₄₈ group, independently of the other, is selected from C₁-C₄alkyl, hydroxyalkyl and C₂-C₄alkenyl groups;
T is either —O—C(O)— or —C(O)—O—, and
each R₄₉ group, independently of the other, is selected from C₈-C₂₈-alkyl and -alkenyl groups; and
e is an integer from 0 to 5.

A second preferred quaternary ammonium type may be represented by the formula: 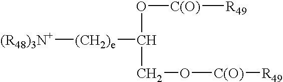
wherein R₄₈, e and R₄₉ are as defined above.

(2) Cyclic quaternary ammonium salts of the imidazolinium type, for example di(hydrogenated tallow)dimethylimidazolinium dimethyl sulfate, 1-ethylene-bis(2-tallow-1-methyl)imidazolinium dimethyl sulfate and the like;

(3) Diamido quaternary ammonium salts, for example: methyl bis(hydrogenated tallow-amidoethyl)-2-hydroxethylammonium dimethyl sulfate, methyl bis(tallowamidoethyl)-2-hydroxypropylammonium dimethyl sulfate and the like;

(4) Biodegradable quaternary ammonium salts, such as N,N-di(tallowoyl-oxy-ethyl)-N,N-dimethylammonium dimethyl sulfate and N,N-di(tallowoyl-oxy-propyl)-N,N-dimethyl -ammonium dimethyl sulfate. Biodegradable quaternary ammonium salts are described, for example in U.S. Pat. Nos. 4,137,180, 4,767,547 and 4,789,491 and are included herein by those literature references.

Preferred biodegradable quaternary ammonium salts include the biodegradable cationic diester compounds, such as are described in U.S. Pat. No. 4,137,180, and are included herein by that literature reference.

(ii) Tertiary fatty amines containing at least one, preferably two, C₈-C₃₀-, especially C₁₂-C₂₂-alkyl chains. Examples include hardened tallow dimethylamine and cyclic amines, such as 1-(hydrogenated tallow)amidoethyl-2-(hydrogenated tallow)imidazoline. Cyclic amines, which may be used for the compositions herein, are described in U.S. Pat. No. 4,806,255 and are included herein by that literature reference.

(iii) Carboxylic acids containing from 8 to 30 carbon atoms and one carboxyl group per molecule. The alkyl moiety contains from 8 to 30 carbon atoms, preferably from 12 to 22 carbon atoms. The alkyl moiety may be linear or branched, saturated or unsaturated, linear saturated alkyl being preferred. Stearic acid is a preferred fatty acid for use in the composition of this invention. Examples of such carboxylic acids are stearic acid and palmitic acid of commercial grade and mixtures thereof, which may contain small amounts of other acids.

(iv) Ester of polyhydric alcohols, for example sorbitan esters or glycerol stearate. Sorbitan esters are the condensation products of sorbitol or isosorbitol with fatty acids, for example stearic acid. Sorbitan esters to which preference is given are monoalkyl esters. A typical example of a sorbitan ester is SPAN® 60 (ICI), a mixture of sorbitan and isosorbitol stearates.

(v) Fatty alcohols, ethoxylated fatty alcohols, alkylphenols, ethoxylated alkylphenols, ethoxylated fatty amines, ethoxylated monoglycerides and ethoxylated diglycerides.

(vi) mineral oils, and polyols, for example polyethylene glycol.

Such fabric softeners are described in greater detail in U.S. Pat. No. 4,134,838 and the disclosure thereof is included herein by that literature reference. Preferred fabric softeners for use in this invention are acyclic quaternary ammonium salts. It is also possible to use mixtures of the above-mentioned fabric softeners.

The fabric softener formulation used in this invention preferably contains from approximately 0.1 to approximately 95% by weight of the fabric softener component, based on the total weight of the fabric softener formulation. Preference is given to an amount of from 0.5 to 50% by weight, especially an amount of from 2 to 50% by weight, and more especially an amount of from 2 to 30% by weight.

The amount of cationic polymer in the fabric softener formulation according to the invention is preferably from 0.005 to 15% by weight, based on the total weight of the fabric softener formulation. Preference is given to an amount of from 0.01 to 10% by weight, especially an amount of from 0.05 to 5% by weight, and more especially an amount of from 0.1 to 5% by weight.

The fabric softener formulation may also comprise additives customary for commercial fabric softener compositions, for example alcohols, such as ethanol, n-propanol, isopropanol, polyhydric alcohols, for example glycerol and propylene glycol; amphoteric and non-anionic surfactants, for example carboxyl derivatives of imidazole, ethoxylated fatty alcohols, hydrogenated and ethoxylated castor oil, alkyl polyglycosides, for example decyl polyglucose and dodecyl polyglucose, fatty alcohols, fatty acid esters, fatty acids, ethoxylated fatty acid glycerides or fatty acid partial glycerides; also inorganic or organic salts, for example water-soluble potassium, sodium or magnesium salts; non-aqueous solvents; pH buffers; fragrances; colorants; hydrotropic agents; anti-foams; anti-greying agents; enzymes; optical brighteners; anti-shrinkage agents; stain removers; germicides; fungicides; dye fixing agents or dye-transfer inhibitors (as described in WO-A-02/02865); antioxidants; corrosion inhibitors; crease recovery agents or wet-stain inhibitors, for example polyorganosiloxanes. The latter two additives are described in WO 0125385.

Such additives are preferably used in an amount of from 0 to 30% by weight, based on the total weight of the fabric softener formulation. Preferably, an amount of from 0 to 20% by weight is used, especially an amount of from 0 to 10% by weight, and more especially an amount of from 0 to 5% by weight.

The fabric softener formulations are preferably in liquid-aqueous form. The fabric softener formulations preferably have a water content of from 25 to 90% by weight, based on the total weight of the formulation. Especially preferably, the water content is from 50 to 90% by weight, especially from 60 to 90% by weight.

The fabric softener formulations preferably have a pH value of from 2.0 to 9.0, especially a pH value of from 2.0 to 5.0.

The fabric softener formulations can be prepared, for example, as follows:

First, an aqueous formulation of the cationic polymer is prepared in the manner described above. The fabric softener composition according to the invention is usually, but not exclusively, prepared by first of all stirring the active ingredient, that is to say the hydrocarbon-based fabric softener component, In molten form into water after which, if necessary, further desired additives are added and finally the formulation of the cationic polymer is added. The fabric softener composition can also be prepared, for example, by mixing a preformulated fabric softener with the cationic polymer.

Such fabric softener compositions are traditionally prepared in the form of dispersions that contain, for example, up to 30% by weight of active material in water. They usually have a cloudy appearance. Alternative formulations, which normally contain active ingredients in amounts of from 5 to 40% by weight together with solvents, can, however, also be prepared in the form of microemulsions, which have a clear appearance (with regard to the solvents and formulations see, for example, U.S. Pat. No. 5,543,067 and WO-A-98/17757).

A very much preferred fabric softener formulation according to the invention is in liquid form and contains:
A) from 0.5 to 50% by weight, based on the total weight of the fabric softener formulation, of at least one fabric softener component;
B) from 0.005 to 15% by weight, based on the total weight of the fabric softener formulation, of at least one thickener, especially a polymeric thickener,
C) from 0.1 to 70% by weight, of at least one solid composition consisting of
   (i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
   (ii) from 5 to 80% by weight, based on the total weight of the solid composition, of polyalkylene, silicone oil, polydimethylsiloxane, fatty acid alkanolamide and/or polyurethane, or a mixture thereof and
   (iii) from 0 to 10% by weight water, based on the total weight of the solid composition,
D) from 0 to 20% by weight, based on the total weight of the fabric softener formulation, of at least one further customary adjuvant, and
E) water to 100% by weight, based on the total weight of the fabric softener formulation.

The fabric softener formulations may also be used in the form of a sheet for use in a dryer. In such application forms, the compositions are usually incorporated in impregnating agents on non-woven webs. Other application forms, however, are also known.

The washing agent and fabric softener formulations, and also the other washing agent additives mentioned above, are used especially in the treatment of textile fibre materials. As textile fibre materials there come into consideration, for example, hydroxy-group-containing and amino-group-containing fibre materials. Examples that may be mentioned include polyamide, wool and, especially, natural or regenerated cellulose.

The present invention furthermore includes solid compositions consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions, and
(ii) from 5 to 80% by weight, based on the total weight of the solid composition, of one or more liquids.

Despite their high liquid content, the novel solid compositions are pulverulent.

The liquid is substantially uniformly distributed in the novel solid compositions.

It is also possible to use emulsions of one or more non-aqueous liquids instead of the pure non-aqueous liquid.

The solid compositions according to the invention comprise, as liquids, preferably polyalkylene emulsions, silicone oils, polydimethylsiloxanes, fatty acid alkanolamides or polyurethanes, or mixtures thereof.

All of the definitions and preferred meanings mentioned above for the carrier materials, for the liquids and the emulsion thereof apply likewise to the novel solid compositions.

A preferred embodiment of the present invention furthermore comprises solid compositions consisting of
(i) at least one carrier material from the group consisting of wood flour; papermaking fibres; activated carbon; natural fibres and fabric; cellulose materials; macroporous adsorber resins; crosslinked polyacrylic acids or highly dispersed, solid polymer compounds formed by polymerisation, polycondensation or by polyaddition reactions or by a combination of such reactions,
(ii) from 20 to 80% by weight, especially from 30 to 80% by weight, more especially from 30 to 75% by weight, based on the total weight of the solid composition, of polyalkylene, silicone oils, polydimethylsiloxane, fatty acid alkanolamide, and/or polyurethane, or a mixture thereof and
(iii) from 0 to 10% by weight water, based on the total weight of the solid composition.

The novel solid compositions may be granules.

The following Examples (Preparation Examples for solid compositions) serve to illustrate the invention without limiting the invention thereto. Unless indicated otherwise, in the following Examples percentages are by weight and the temperature is given in degrees Celsius.

### EMBODIMENT EXAMPLES

### Example 1

5 parts of a polyalkylene emulsion having a solids content of 24% and 5 parts of fibrous cellulose (Arbocel BC200, manufacturer: J. Rettenmaier) are mixed together. After drying, a powder-like material is obtained which, on storage, does not become sticky and can be further compacted. The content of active ingredient is about 20%.

### Example 2

16 parts of a polysiloxane emulsion having a solids content of 40% and 5 parts of a urea-formaldehyde polymer compound having a solids content of 76% (Pergopak M, manufacturer: Martinswerk) are mixed together and the resulting moist mass is subsequently dried at 70° C. The material so obtained contains about 60% active ingredient, is storage-stable and can be compacted to form break-resistant and abrasion-resistant compacts.

### Example 3

Drying a mixture of 20 parts of a polyurethane solution (Turpex VU, manufacturer: Ciba) and 5 parts of Pergopak M (manufacturer: Martinswerk) yields a storage-stable powder having an active ingredient content of about 60%, which can be compressed into tablets and compacted.

### Example 4

A mixture of 10 parts of a pure silicone oil (Ultratex 7649, manufacturer: Ciba) and 5 parts of Pergopak M (manufacturer: Martinswerk) yields, after the removal of residual water by drying, a storable and compactible powder having a silicone oil content of about 70%.

1. A washing agent formulation or fabric softener formulation that comprises at least one solid composition consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions, and
(ii) from 5 to 80% by weight, based on the total weight of the solid composition, of one or more liquids.

2. A washing agent formulation or fabric softener formulation according to claim 1, wherein the solid composition is pulverulent.

3. (canceled)

4. A washing agent formulation or fabric softener formulation according to claim 1, wherein the solid composition is present in an emulsion of one or more non-aqueous liquids.

5. A washing agent formulation or fabric softener formulation according to claim 1, wherein the liquid in the solid composition is a polyalkylene emulsion, a silicone oil, a polydimethylsiloxane, a fatty acid alkanolamide, a polyurethane, or a mixture thereof.

6. A washing agent formulation or fabric softener formulation according to claim 1, wherein the content of liquid in the solid composition is from 15 to 80% by weight, based on the total weight of the solid composition.

7. A washing agent formulation or fabric softener formulation according to claim 1 comprising at least one solid, pulverulent composition consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions,
(ii) from 5 to 80% by weight, based on the total weight of the solid composition, of one or more liquids, and
(iii) from 0 to 10% by weight water, based on the total weight of the solid composition.

8. A washing agent formulation or fabric softener formulation according to claim 1, wherein the solid, pulverulent composition is in the form of granules.

9. A method of treating an article comprising contacting said article with a washing agent formulation or fabric softener formulations, having at least one solid composition consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions, and
(ii) from 5 to 80% by weight, based on the total weight of the composition, of one or more liquids.

10. A method according to claim 9, wherein the solid composition is pulverulent.

11. (canceled)

12. A method according to claim 9, wherein an emulsion of one or more liquids is present.

13. A method according to claim 12, wherein the liquid is a polyalkylene emulsion, a silicone oil, a polydimethylsiloxane, a fatty acid alkanolamide, and/or a polyurethane, or a mixture thereof.

14. A method according to claim 13, wherein the content of liquid is from 15 to 80% by weight, based on the total weight of the solid composition.

15. A method according to claim 9, wherein there is present at least one solid, pulverulent composition consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions,
(ii) from 20 to 80% by weight, especially from 30 to 80% by weight, more especially from 30 to 75% by weight, based on the total weight of the solid composition, of a polyalkylene, a silicone oil, a polydimethylsiloxane, a fatty acid alkanolamide, a polyurethane, or a mixture thereof, and
(iii) from 0 to 10% by weight water, based on the total weight of the solid composition.

16. A method according to claim 15, wherein the solid, pulverulent composition is in the form of granules.

17. A washing agent formulation according to claim 1 containing
I) from 5 to 90% A) of at least one anionic surfactant or B) at least one non-ionic surfactant, based on the total weight of the washing agent formulation,
II) from 5 to 70% C) of at least one builder substance, based on the total weight of the washing agent formulation,
III) from 0 to 30% D) of at least one peroxide and, optionally, at least one activator, based on the total weight of the washing agent formulation,
IV) from 0.1 to 70% E) of at least one solid composition as defined in claim 1, based on the total weight of the washing agent formulation,
V) from 0 to 60% F) of at least one further additive, based on the total weight of the washing agent formulation, and
VI) from 0 to 12% G) water, based on the total weight of the washing agent formulation.

18. A washing agent formulation according to claim 17 containing
I) from 5 to 90% A) of at least one anionic surfactant selected from the group consisting of C₁₂-C₂₂alkyl ethoxysulfates in which the alkyl radical contains from 10 to 20 carbon atoms and in which the head group contains on average 2 or 3 ethoxy units; alkyl benzenesulfonates having from 9 to 15 carbon atoms in the alkyl radical; alkyl naphthalenesulfonates having from 6 to 16 carbon atoms in the alkyl radical in question; and alkali metal sarcosinates of formula R₄₆—CO—N(R₄₇)—CH₂COOM₁,
wherein R₄₆ is alkyl or alkenyl having from 8 to 18 carbon atoms in the alkyl or alkenyl radical,
R₄₇ is C₁-C₄alkyl and
M₁ is an alkali metal,
B) of at least one non-ionic surfactant selected from the group consisting of condensation products of from 3 to 8 mol of ethylene oxide with 1 mol of a primary alcohol, which alcohol contains from 9 to 15 carbon atoms,
based on the total weight of the washing agent formulation, or a mixture of A) and B).
II) from 5 to 70% C) of a builder substance selected from the group consisting of alkali metal phosphates; carbonates; hydrogen carbonates; silicates; aluminium silicates; polycarboxylates; polycarboxylic acids; organic phosphonates and aminoalkylenepoly(alkylenephosphonates), based on the total weight of the washing agent formulation,
III) from 0 to 30% D) of a peroxide selected from the group consisting of organic mono- or poly-peroxides; organic peracids or salts thereof; persulfates; perborates; percarbonates; and persilicates, based on the total weight of the washing agent formulation,
IV) from 0.1 to 70% E) of the solid composition, based on the total weight of the washing agent formulation,
V) from 0 to 60% F) of further additives selected from the group consisting of optical brighteners; suspending agents for dirt; pH regulators; foam regulators; salts for regulating the spray-drying and granulating properties; fragrances; antistatics; fabric softeners; enzymes; bleaching agents; pigments; toning agents; also polymers which, during the washing of textiles, prevent staining caused by dyes in the washing liquor which have been released from the textiles under the washing conditions; and bleaching agent activators, based on the total weight of the washing agent formulation, and
VI) from 0 to 12% G) water, based on the total weight of the washing agent formulation.

19. A fabric softener formulation according to claim 1 containing:
A) from 0.5 to 50% by weight, based on the total weight of the fabric softener formulation, of at least one fabric softener component,
B) from 0.005 to 15% by weight, based on the total weight of the fabric softener formulation, of at least one thickener,
C) from 0.1 to 70% by weight, based on the total weight of the fabric softener formulation, of at least one solid composition as previously defined,
D) from 0 to 20% by weight, based on the total weight of the fabric softener formulation, of at least one further customary adjuvant, and
E) water to 100% by weight, based on the total weight of the fabric softener formulation.

20. A solid composition consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions, and
(ii) from 5 to 80% by weight, based on the total weight of the composition, of one or more liquids.

21. (canceled)

22. (canceled)

23. A composition according to claim 20, wherein there is present an emulsion of one or more non-aqueous liquids.

24. A composition according to claim 23, wherein the liquid is a polyalkylene emulsion, a silicone oil, a polydimethylsiloxane, a fatty acid alkanolamide or a polyurethane, or a mixture thereof.

25. A composition according to claim 24, wherein the content of non-aqueous liquid is from 15 to 80% by weight, based on the total weight of the solid composition.

26. A solid, pulverulent composition according to claim 20 consisting of
(i) at least one carrier material selected from the group consisting of wood flour; papermaking fibres; activated carbon; natural fibres and fabric; cellulose materials; macroporous adsorber resins; crosslinked polyacrylic acids and highly dispersed, solid polymer compounds formed by polymerisation, polycondensation or by polyaddition reactions or by a combination of such reactions,
(ii) from 20 to 80% by weight, based on the total weight of the solid composition, of a polyalkylene, a silicone oil, a polydimethylsiloxane, a fatty acid alkanolamide, a polyurethane, or a mixture thereof and
(iii) from 0 to 10% by weight water, based on the total weight of the solid composition.

27. Granules comprising a composition according to claim 20.
